(19) United States
(12) Patent Application Publication
(10) Pub. No.: US 2026/0362179 A1
(43) Pub. Date: Nov. 12, 2026

(54) SYSTEMS AND METHODS FOR ENHANCING PACKET DATA UNIT SESSION MONITORING IN CORE NETWORKS

(71) Applicant: Verizon Patent and Licensing Inc., Basking Ridge, NJ (US)

(72) Inventors: Ye HUANG, San Ramon, CA (US); Burhan SYED, Bridgewater, NJ (US); Michael KONDRATIUK, Hillsborough, NJ (US)

(73) Assignee: Verizon Patent and Licensing Inc., Basking Ridge, NJ (US)

(21) Appl. No.: 19/205,113

(22) Filed: May 12, 2025

(51) Int. Cl. H04W 24/08

(52) U.S. Cl. CPC H04W 24/08

(57) ABSTRACT

A first network device may enable retrieval control options for a packet data unit (PDU) session of a user equipment in a core network. The first network device may receive information associated with the PDU session from the second network device based on the retrieval control options, and may receive a notification of a change to the PDU session from the second network device. The first network device may provide enhanced monitoring and reporting capabilities for the PDU session based on one of the information associated with the PDU session or the notification of the change to the PDU session.

### BACKGROUND

Within fifth generation (5G) network infrastructure, there exists a service that enables third-party applications to interact with user equipment (UE) packet data unit (PDU) sessions.

### BRIEF DESCRIPTION OF THE DRAWINGS

FIGS. 1A-1E are diagrams of an example associated with enhancing PDU session monitoring in core networks.

FIGS. 2 and 3 are diagrams of example environments in which systems and/or methods described herein may be implemented.

FIG. 4 is a diagram of example components of one or more devices of FIGS. 2 and 3.

FIG. 5 is a flowchart of an example process for enhancing PDU session monitoring in core networks.

### DETAILED DESCRIPTION OF EXAMPLE EMBODIMENTS

The following detailed description of example implementations refers to the accompanying drawings. The same reference numbers in different drawings may identify the same or similar elements.

The service that enables third-party applications to interact with UE PDU sessions is essential for functions, such as on-demand quality of service (QoS) adjustments and monitoring UE connectivity. However, the development and deployment of application programming interface (API) services for translation of a UE identifier (ID) to a UE Internet protocol (IP) address and translation of the UE IP address to the UE ID, as well as UE monitoring for PDU sessions, have been constrained by slowly developed solutions based on the Third Generation Partnership Project (3GPP) standards. Despite the adoption of these standards in the 3GPP for fourth generation (4G) core networks, and ongoing efforts to extend the standards to 5G core networks, the actual deployment of the necessary services in a 5G standalone (SA) architecture has been a challenge. The deployment of the services poses a significant challenge to the industry, as the services are fundamental to the UE monitoring API for PDU session exposure.

Additionally, there is a potential capacity impact on a session management function (SMF) as the demand for UE monitoring of PDU sessions increases across various platforms, such as consumer, Internet of Things (IoT), telematics, and fixed wireless access (FWA). The current 3GPP standard-based methods rely heavily on the SA deployment and are limited by the infrastructure equipment.

Thus, current techniques for providing the service that enables third-party applications to interact with UE PDU sessions consume computing resources (e.g., processing resources, memory resources, communication resources, and/or the like), networking resources, and/or other resources associated with managing the development in accordance with the 3GPP standards, gating of the service that enables third-party applications to interact with UE PDU sessions based on deployment of the 5G SA architecture, providing strain on network components due to increased demand for UE monitoring of PDU sessions, and/or the like.

Some implementations described herein provide a first network device that enhances PDU session monitoring in core networks. For example, the first network device may enable retrieval control options for a PDU session of a UE in a core network. The first network device may receive information associated with the PDU session from the second network device based on the retrieval control options, and may receive a notification of a change to the PDU session from the second network device. The first network device may provide enhanced monitoring and reporting capabilities for the PDU session based on one of the information associated with the PDU session or the notification of the change to the PDU session.

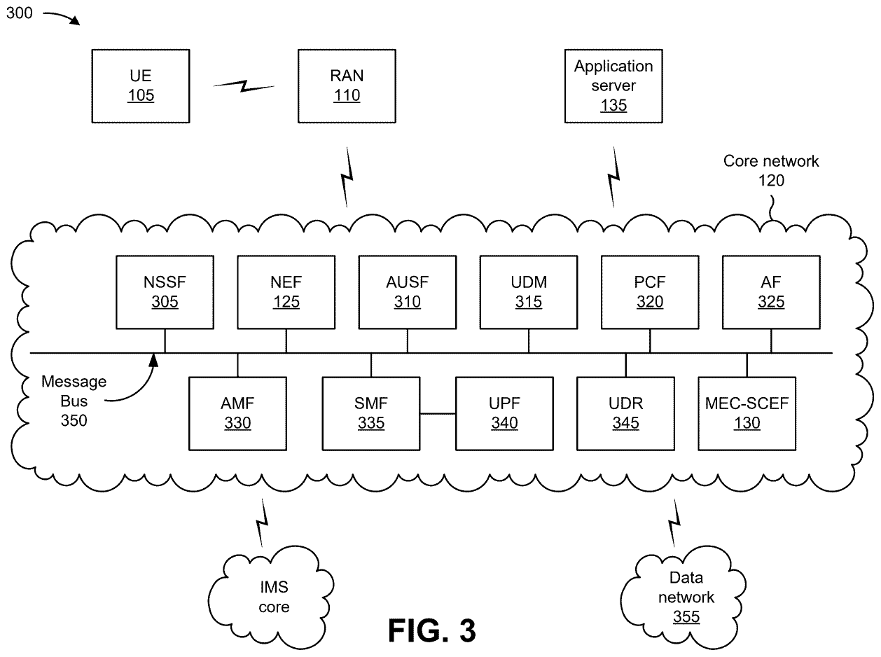

In this way, the first network device (e.g., a network exposure function (NEF) or other network functions identified in FIG. 3) enhances PDU session monitoring in core networks. For example, the NEF may significantly enhance technical capabilities for UE PDU session monitoring within 5G network infrastructures. By enabling immediate retrieval control and interworking with a multi-access edge computing service capability exposure function (MEC-SCEF), the NEF may facilitate rapid receipt and processing of PDU session information. Such real-time monitoring and reporting may bypass traditional delays inherent in standardization processes, and may provide a streamlined approach for applications that depend on timely QoS assessments and connectivity evaluations. The NEF may receive information associated with PDU sessions from the MEC-SCEF, as well as notifications of any changes to the PDU sessions. The NEF may receive immediate reports upon request, and may subscribe to and receive information about multiple PDU sessions for multiple UEs. The NEF may store pertinent PDU session information, such as a radio access technology (RAT) type, a cell identifier (ID), and network address translation (NAT) processed network addresses. The comprehensive data set, including the RAT type, the cell ID, and the NAT processed network addresses, may provide a more detailed perspective of the UE's network context, which is currently not fully captured by existing standards. This allows for more effective network resource management and optimization of service delivery protocols, leading to improved overall network functionality and efficiency.

Thus, the NEF (or other network functions) may conserve computing resources, networking resources, and/or other resources that would have otherwise been consumed by managing the slow pace of development in accordance with the standards, gating of the service that enables third-party applications to interact with UE PDU sessions based on deployment of the 5G SA architecture, providing strain on network components due to increased demand for UE monitoring of PDU sessions, and/or the like.

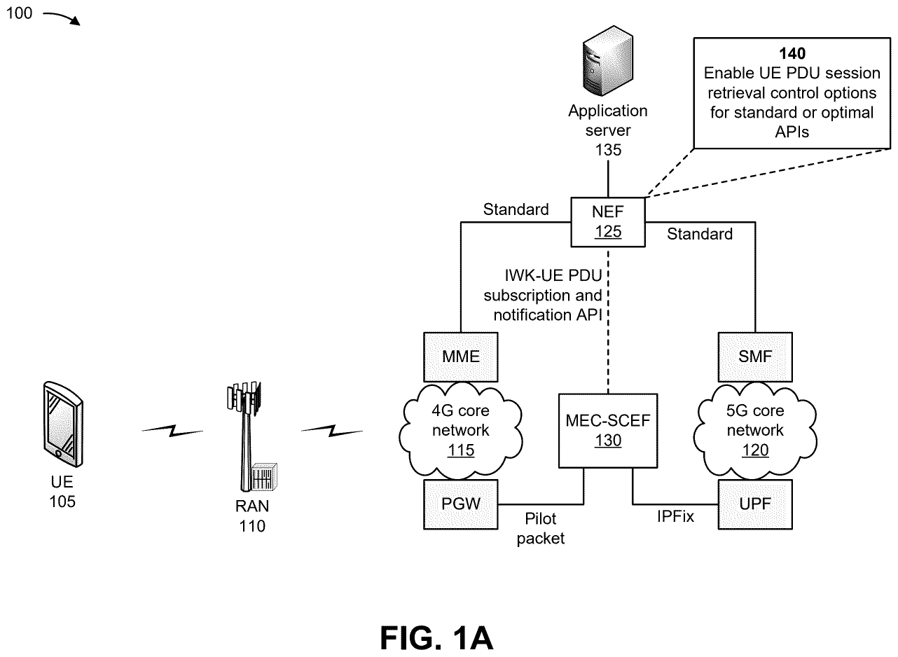

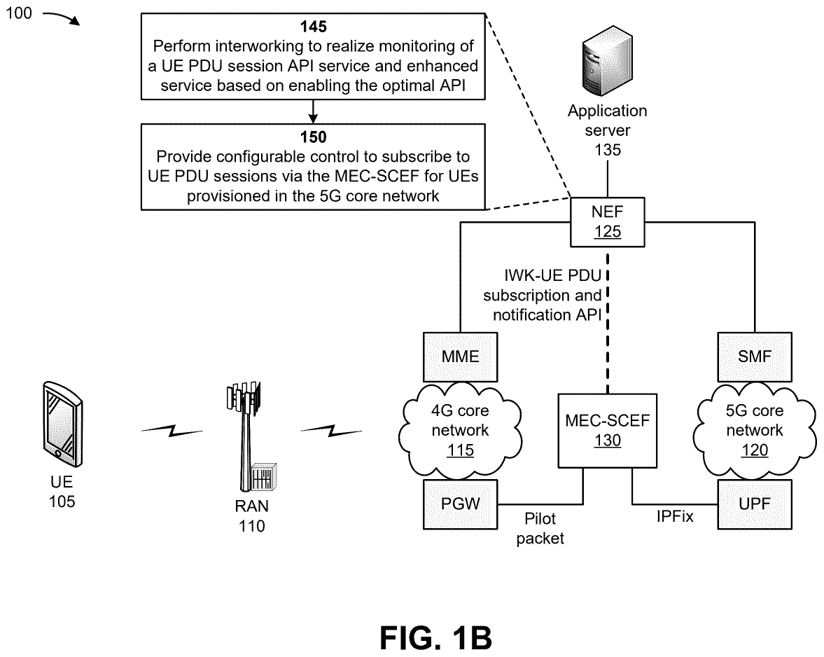

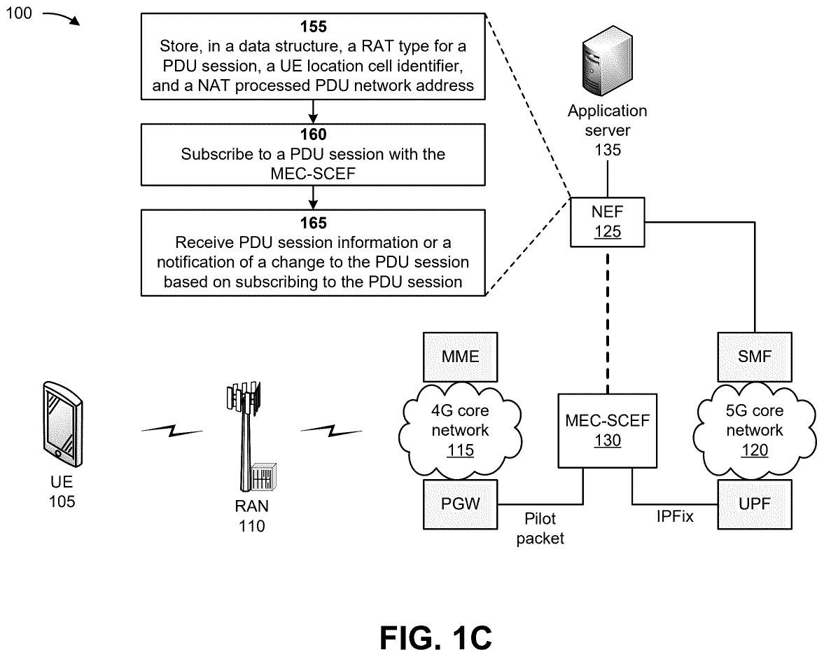

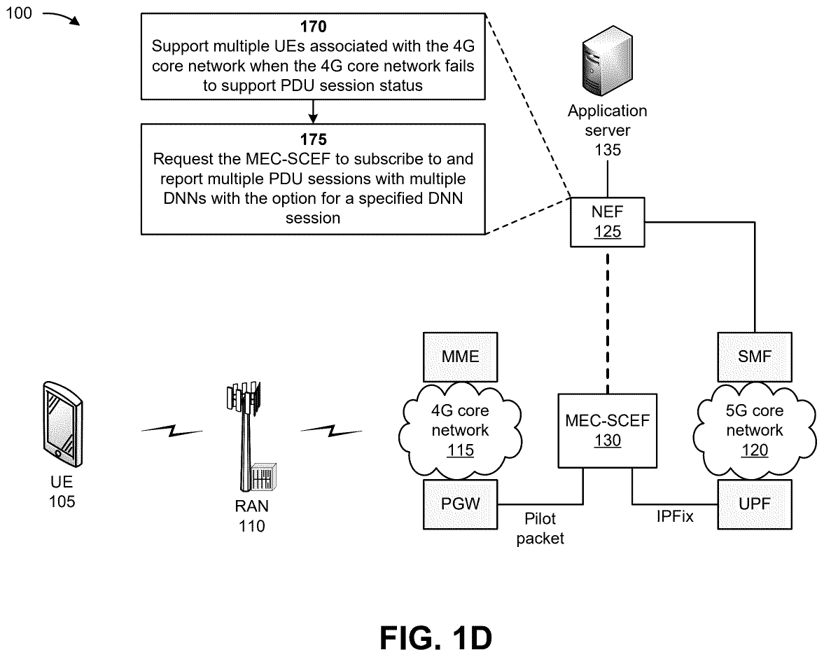

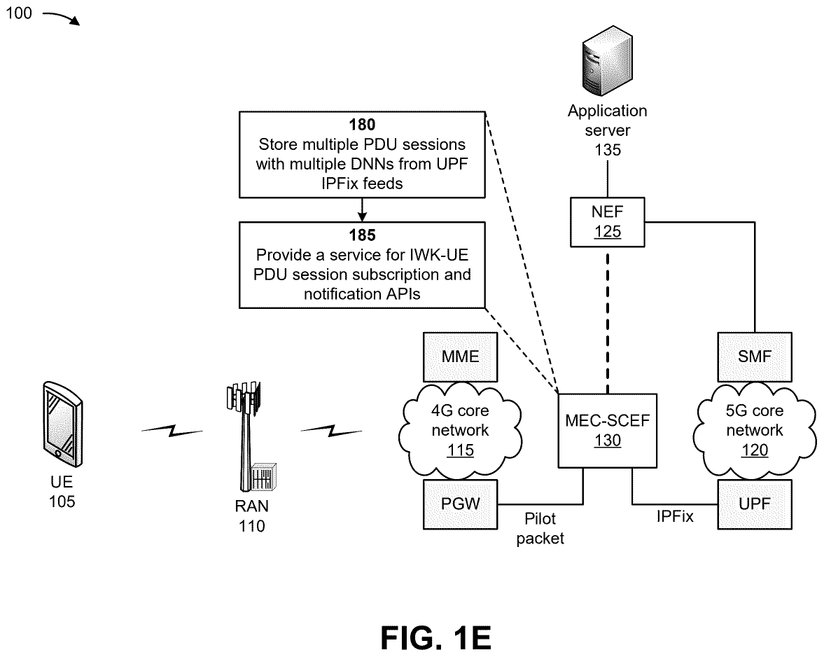

FIGS. 1A-1E are diagrams of an example 100 associated with enhancing PDU session monitoring in core networks. As shown in FIGS. 1A-1E, the example 100 includes a UE 105, a radio access network (RAN) 110, a 4G core network 115, a 5G core network 120, a network exposure function (NEF) 125, a multi-access edge computing service capability exposure function (MEC-SCEF) 130, and an application server 135. The 4G core network 115 may include a mobility management entity (MME) and a packet data network gateway (PGW). The 5G core network 120 may include a session management function (SMF) and a user plane function (UPF). Further details of the UE 105, the RAN 110, the 4G core network 115, the 5G core network 120, the NEF 125, the MEC-SCEF 130, the application server 135, the MME, the PGW, the SMF, and the UPF are provided elsewhere herein.

As shown in FIG. 1A, the NEF 125 may include standard interfaces (APIs) with the MME and the SMF. The NEF 125 may include interworking UE (IWK-UE) PDU subscription and notification APIs with the MEC-SCEF 130. The IWK-UE PDU API may include an interface that facilitates communication and interoperability between different network functions or devices in a telecommunications network, specifically for managing and monitoring PDU sessions of UEs. In the context of 5G and 4G core networks, this API may allow network functions, such as the NEF 125 and the MEC-SCEF 130 to interact with each other and with third-party applications. The API may enable these network functions to subscribe to PDU session information, receive notifications about PDU session information, and retrieve PDU session information. The IWK-UE PDU API may translate UE identifiers to IP addresses and vice versa, and may provide real-time updates and monitoring capabilities for PDU sessions. In some implementations, the UE 105 may wirelessly connect with the RAN 110, and the RAN 110 may enable the UE 105 to communicate with the 4G core network 115, the 5G core network 120, and/or the application server 135.

As further shown in FIG. 1A, and by reference number 140, the NEF 125 may enable UE PDU session retrieval control options for the standard API or an optimal API (e.g., the IWK-UE PDU API). For example, the NEF 125 may be configured with retrieval control options that allow for selective monitoring of PDU sessions based on the standard API or the optimal API. The optimal API, also known as the IWK-UE PDU API, may provide enhanced capabilities for real-time updates, subscriptions to multiple PDU sessions, and immediate reporting. Additionally, or alternatively, the optimal API may provide for enhanced monitoring and reporting capabilities, and more customization for service providers. Additionally, or alternatively, the retrieval control options may enable the NEF 125 to switch between using the standard API and the IWK-UE PDU API for monitoring PDU sessions. This flexibility may ensure that the NEF 125 can dynamically adapt to various network scenarios and requirements.

As shown in FIG. 1B, and by reference number 145, the NEF 125 may perform interworking (e.g., with MEC-SCEF 130) to realize monitoring of a UE PDU session API service and an enhanced service based on enabling the optimal API. For example, when the NEF 125 selects the optimal API (e.g., the IWK-UE PDU API), the NEF 125 may interwork with the MEC-SCEF 130 to facilitate the exchange and processing of PDU session information, and to enable real-time updates and notifications regarding the PDU sessions. This interworking may provide for more efficient monitoring and reporting functionalities, and may bypass traditional delays inherent in the processes. In some implementations, the interworking may include the NEF 125 enabling real-time monitoring and management of UE PDU sessions. For example, the NEF 125 may facilitate the exchange of PDU session data with the MEC-SCEF 130, which may provide immediate reporting and notifications, and the ability to manage multiple PDU sessions simultaneously. Alternatively, or additionally, the NEF 125 may interwork with MEC-SCEF 130 to enable the NEF 125 to receive comprehensive PDU session information, including a RAT type of the UE 105, a cell identifier of the UE 105, and NAT processed network addresses of the UE 105, which may provide for efficient network resource management and optimization of service delivery protocols.

By interworking with the MEC-SCEF 130, the NEF 125 may provide more efficient and real-time monitoring and reporting capabilities. When the NEF 125 selects the optimal API, the NEF 125 may interwork with the MEC-SCEF 130 to facilitate the exchange and processing of PDU session information. In some implementations, the NEF 125 may receive notifications of any changes to the PDU sessions from the MEC-SCEF 130, such as the addition or removal of PDU sessions. This may ensure that the NEF 125 is always up-to-date with the current status of the PDU sessions. By receiving detailed PDU session information and real-time updates, the NEF 125 may manage network resources more effectively. This may provide optimized service delivery protocols and improved overall network functionality and efficiency. Furthermore, the ability of the NEF 125 to dynamically switch between APIs and support multiple UEs 105 may ensure that the NEF 125 can scale efficiently as the demand for UE monitoring of PDU sessions increases across various platforms.

As further shown in FIG. 1B, and by reference number 150, the NEF 125 may provide configurable control to subscribe to UE PDU sessions via the MEC-SCEF 130 for UEs 105 provisioned in the 5G core network 120. For example, the NEF 125 may be configured to subscribe to specific PDU sessions and receive pertinent updates and notifications from the MEC-SCEF 130 regarding the specific PDU sessions. This may provide for enhanced monitoring and reporting capabilities tailored to the specific needs of service providers, and may ensure that the NEF 125 may dynamically manage and optimize network resources effectively. In some implementations, subscribing to UE PDU sessions may include the NEF 125 offering configurable options to subscribe to UE PDU sessions through the MEC-SCEF 130 for UEs 105 in the 5G core network 120. This may provide for personalized monitoring and reporting based on specific requirements of service providers.

As shown in FIG. 1C, and by reference number 155, the NEF 125 may store, in a data structure (e.g., a database, a table, a list, and/or the like), a RAT type for a PDU session, a UE location cell identifier, and a NAT processed PDU network address. For example, the NEF 125 may store information related to the PDU session in a data structure associated with the NEF 125. The information related to the PDU session may include a type of RAT utilized, a specific cell identifier of the UE 105, a NAT processed network address for the PDU session, and/or the like. The storage of the information related to the PDU session may provide for efficient retrieval and management of pertinent PDU session information, and may enhance the monitoring and reporting capabilities of the NEF 125. In some implementations, the NEF 125 may store the PDU session information in a data repository (e.g., a relational database, a structured query language (SQL) database, a key-value store, or an object storage system) associated with the NEF 125. Additionally, or alternatively, the NEF 125 may utilize the stored PDU session information, including the RAT type, the UE location cell identifier, and the NAT processed PDU network address, to provide enhanced analytics and reporting functionalities for the PDU sessions. The NEF 125 may utilize the analytics to generate detailed reports that may aid in network management decisions. Additionally, or alternatively, the NEF 125 may utilize a machine learning model to analyze the stored PDU session information for predictive insights and anomaly detection, thereby improving the overall efficiency of network management. For example, the NEF 125 may predict potential network issues based on the PDU session information and may take preemptive actions to mitigate the potential network issues.

As further shown in FIG. 1C, and by reference number 160, the NEF 125 may subscribe to a PDU session with the MEC-SCEF 130. For example, the NEF 125 may request, from the MEC-SCEF 130, a subscription to receive updates and relevant PDU session information. The subscription may enable the NEF 125 to stay informed about the status and changes of the PDU session, allowing for real-time monitoring and management. In some implementations, the NEF 125 may subscribe to multiple PDU sessions via the MEC-SCEF 130. By subscribing to multiple PDU sessions, the NEF 125 may receive updates and relevant PDU session data, and may perform continuous monitoring and management of various PDU sessions. This may include subscribing to different PDU sessions associated with multiple UEs 105. Additionally, or alternatively, the NEF 125 may adjust the subscriptions to PDU sessions in response to changing network demands or policies. This may ensure that the NEF 125 can adapt to varying conditions and requirements. Additionally, or alternatively, the NEF 125 may store (e.g., in the data structure) additional PDU session attributes, such as a PDU session duration, data throughput, and latency metrics. The additional PDU session attributes may provide a more comprehensive view of PDU session performance, and may be utilized for detailed network analysis and optimization.

As further shown in FIG. 1C, and by reference number 165, the NEF 125 may receive PDU session information or a notification of a change to the PDU session based on subscribing to the PDU session. For example, the NEF 125 may receive, from the MEC-SCEF 130 and based on the subscriptions, detailed session information or notifications indicating changes to PDU sessions, such as additions or removals of PDU sessions. The real-time PDU session information and notifications may ensure that the NEF 125 can provide up-to-date monitoring and reporting services for the PDU sessions. In some implementations, the NEF 125 may trigger specific actions, such as adjusting QoS parameters or reallocating network resources, based on the PDU session change notifications received from the MEC-SCEF 130. For example, if a high-priority PDU session is added, the NEF 125 may allocate more resources to ensure optimal performance. Additionally, or alternatively, the NEF 125 may interact with the application server 135 to provide real-time PDU session data and notifications. This may enable the application server 135 to optimize services based on current network conditions, and to provide seamless service delivery and improved user experience. In some implementations, the NEF 125 may provide a NAT processed network address associated with the UE 105 to the application server 135, or may provide an updated NAT processed network address associated with the UE 105 to the application server 135 (e.g., when a traffic flow is updated with a new NAT processed network address associated with the UE 105).

As shown in FIG. 1D, and by reference number 170, the NEF 125 may support multiple UEs 105 associated with the 4G core network 115 when the 4G core network 115 (e.g., the MME) fails to support PDU session status. For example, the NEF 125 may provide monitoring and reporting capabilities for the PDU sessions of UEs 105 in the 4G core network 115, even when the 4G core network 115 (e.g., the MME) is unable to support PDU session status. This may ensure that the NEF 125 can manage and report the PDU sessions of UEs 105 regardless of the limitations of the 4G core network 115. In some implementations, if the MME of the 4G core network 115 does not support PDU session status, the NEF 125 may ensure that the PDU sessions for UEs 105 associated with the 4G core network 115 are still monitored and reported accurately. For example, the NEF 125 may maintain PDU session data and may provide status updates even when the MME fails to support PDU session status. A PDU session status may include a current state or condition of a PDU session in the 4G core network 115. The status of a PDU session can include various attributes, such as attributes indicating that the PDU session is currently active and transmitting data, that the PDU session is inactive or terminated, QoS parameters (e.g., latency, jitter, packet loss, and throughput) of the PDU session, an amount of data transmitted and received during the PDU session, a length of time that the PDU session has been active, a type of RAT being used for the PDU session, an identifier of the cell in which the UE 105 is currently connected, an IP address assigned to the UE 105, any changes to the PDU session (e.g., handovers between cells, changes in QoS parameters, or session terminations), and/or the like.

As further shown in FIG. 1D, and by reference number 175, the NEF 125 may request the MEC-SCEF 130 to subscribe to and report multiple PDU sessions with multiple data network names (DNNs) with the option for a specified DNN session. For example, the NEF 125 may communicate with the MEC-SCEF 130 to subscribe to various PDU sessions associated with different DNNs. This may enable the NEF 125 to receive updates and notifications about these PDU sessions, and to provide comprehensive monitoring and reporting capabilities. Additionally, the NEF 125 may specify particular DNN sessions for targeted reporting, which may provide customized service delivery based on specific network requirements. For example, the NEF 125 may target specific DNN sessions that require more detailed monitoring due to higher data traffic, criticality for certain applications or services, and/or the like. Additionally, or alternatively, the NEF 125 may aggregate data from various DNNs to provide a holistic view of network performance. For example, the NEF 125 can use the aggregated data to identify trends, and optimize network resources accordingly.

In some implementations, the NEF 125 may initiate a request to the MEC-SCEF 130 to subscribe to multiple PDU sessions. The request may include specific parameters that define the scope and nature of the subscription. These parameters may include identifiers for the PDU sessions, the DNNs associated with the PDU sessions, and any specific criteria or filters for the subscription. The request from the NEF 125 may include details of multiple DNNs. A DNN may represent a specific data network to which the UE 105 can connect. The NEF 125 may also include an option in the subscription request to focus on a specified DNN session. This means that, in addition to subscribing to multiple DNNs, the NEF 125 can target specific DNN sessions that require more detailed monitoring. Upon receiving the subscription request, the MEC-SCEF 130 may process the request and may establish the necessary subscriptions to the specified PDU sessions and DNNs. The MEC-SCEF 130 may act as an intermediary, and may facilitate the exchange and processing of PDU session information between the 5G core network 120 and the NEF 125. Once the subscription is established, the MEC-SCEF 130 may continuously monitor the PDU sessions and may provide real-time updates and notifications to the NEF 125. These updates may include information about the status of the PDU sessions, any changes or events related to the PDU sessions, and performance metrics.

As shown in FIG. 1E, and by reference number 180, the MEC-SCEF 130 may store multiple PDU sessions with multiple DNNs from IPFix feeds provided by the UPF of the 5G core network 120. For example, the UPF may generate IP flow information export (IPFix) feeds. IPFix is a protocol used for exporting flow information from network devices to a collector (e.g., the MEC-SCEF 130). An IPFix feed may include a data stream that is generated by network devices and sent to a collector or monitoring system for analysis. The IPFix feed may include detailed information about network traffic flows, which can be used for various purposes such as network monitoring, traffic analysis, and security. A network traffic flow may be defined as a set of IP packets passing through an observation point in the network during a certain time interval that share a set of common properties. These properties can include source and destination IP addresses, source and destination port numbers, protocol type, and other relevant information. The UPF may capture the flow information from the network device and may export the flow information to the MEC-SCEF 130. This process involves the creation of flow records, which are then formatted according to the IPFix protocol and sent to the MEC-SCEF 130. The MEC-SCEF 130 may receive the IPFix feeds from the UPF, and may store the IPFix feeds in a data structure associated with the MEC-SCEF 130. In some implementations, the IPFix feeds may include data associated with multiple PDU sessions with multiple DNNs. In some implementations, the MEC-SCEF 130 may use IPFix feeds provided by the UPF to monitor and report the multiple PDU sessions with multiple DNNs. The IPFix feeds may include detailed flow information that helps the MEC-SCEF 130 track the status and performance of the multiple PDU sessions. The MEC-SCEF 130 may utilize this information to provide real-time updates and notifications to the NEF 125.

As further shown in FIG. 1E, and by reference number 185, the MEC-SCEF 130 may provide a service for IWK-UE PDU session subscription and notification APIs. For example, the MEC-SCEF 130 may enable external applications and network functions to subscribe to PDU sessions of UEs 105 via an IWK-UE PDU session subscription service. An external application or network function may provide a subscription request to the MEC-SCEF 130. The request may include parameters, such as the UE identifier, the type of PDU session, and specific criteria for the subscription (e.g., QoS parameters, DNNs, and/or the like). The MEC-SCEF 130 may validate the subscription request to ensure that the requesting entity has the necessary permissions to access the PDU session information. This may involve checking the credentials and authorization levels of the requesting entity. Once the request is validated, the MEC-SCEF 130 may establish the subscription by configuring the necessary monitoring mechanisms within the network. This may include setting up interfaces with the relevant network functions (e.g., the SMF or the UPF) to track the PDU sessions of the specified UEs 105.

After establishing the subscription, the MEC-SCEF 130 may continuously monitor the PDU sessions of the subscribed UEs 105. This may include the MEC-SCEF 130 collecting real-time data related to the PDU sessions from various network functions such as the SMF and the UPF. The data may include information like session status, QoS parameters, data throughput, latency metrics, RAT type, cell identifier, and NAT processed network addresses. The MEC-SCEF 130 may aggregate and process the collected data to provide a comprehensive view of the PDU sessions. The processing may include filtering, summarizing, and analyzing the data to extract relevant insights and metrics. The MEC-SCEF 130 may provide the aggregated and processed data to the requesting entity.

In some implementations, the MEC-SCEF 130 may provide real-time notifications to the subscribed entities about any changes in the PDU sessions. For example, the MEC-SCEF 130 may detect changes in the PDU sessions, such as the addition or removal of PDU sessions, changes in QoS parameters, handovers between cells, and any other significant events. Upon detecting a change, the MEC-SCEF 130 may generate a notification message that includes detailed information about the change. This message may be formatted according to the subscription criteria and the specific requirements of the requesting entity. The MEC-SCEF 130 may provide the notification message to the subscribed entities via the configured APIs. The MEC-SCEF 130 may ensure that the notifications are delivered promptly and reliably, enabling the subscribed entities to take appropriate actions based on the received information. The MEC-SCEF 130 may include APIs that facilitate the subscription to PDU sessions and the provision of notifications. The APIs may include a subscription API that allows external applications and network functions to subscribe to PDU sessions, and a notification API that delivers real-time notifications about changes in PDU sessions to the subscribed entities.

In this way, the first network device (e.g., the NEF 125) enhances PDU session monitoring in core networks. For example, the NEF 125 may significantly enhance technical capabilities for UE PDU session monitoring within 5G network infrastructures. By enabling immediate retrieval control and interworking with the MEC-SCEF 130, the NEF 125 may facilitate rapid receipt and processing of PDU session information. Such real-time monitoring and reporting may bypass traditional delays inherent in processes, and may provide a streamlined approach for applications that depend on timely QoS assessments and connectivity evaluations. The NEF 125 may receive information associated with PDU sessions from the MEC-SCEF 130, as well as notifications of any changes to the PDU sessions. The NEF 125 may receive immediate reports upon request, and may subscribe to and receive information about multiple PDU sessions for multiple UEs 105. The NEF 125 may store pertinent PDU session information, such as a RAT type, a cell ID, and NAT processed network addresses. The comprehensive data set, including the RAT type, the cell ID, and the NAT processed network addresses, may provide a more detailed perspective of the UE's 105 network context, which is currently not fully captured by existing standards. This allows for more effective network resource management and optimization of service delivery protocols, leading to improved overall network functionality and efficiency.

Thus, the NEF 125 may conserve computing resources, networking resources, and/or other resources that would have otherwise been consumed by managing the slow pace of development in accordance with the standards, gating of the service that enables third-party applications to interact with UE PDU sessions based on deployment of the 5G SA architecture, providing strain on network components due to increased demand for UE monitoring of PDU sessions, and/or the like.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

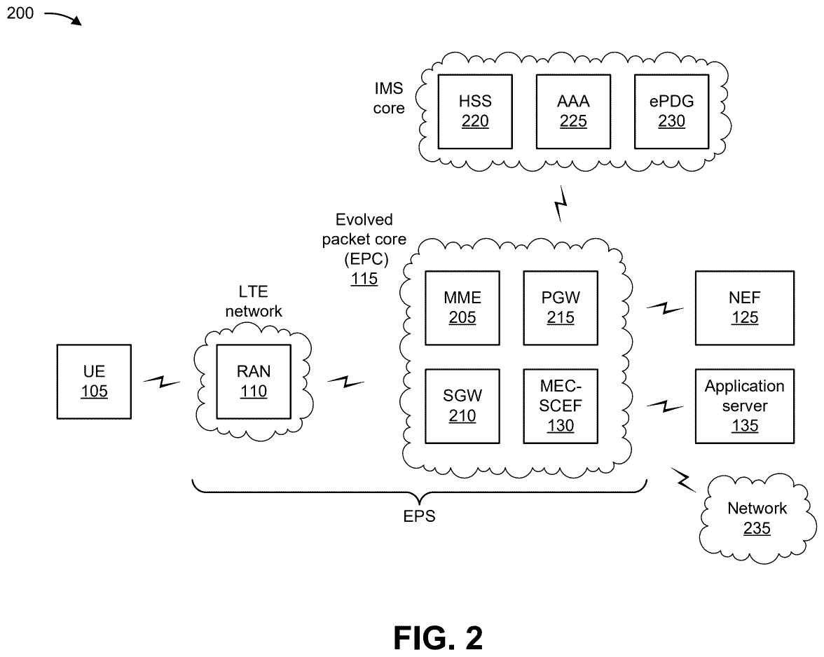

FIG. 2 is a diagram of an example environment 200 in which systems and/or methods, described herein, may be implemented. As shown in FIG. 2, the environment 200 may include the UE 105, the RAN 110, the NEF 125, the MEC-SCEF 130, the application server 135, an MME 205, a serving gateway (SGW) 210, a PGW 215, an Internet protocol (IP) multimedia subsystem (IMS) core with a home subscriber server (HSS) 220, an authentication, authorization, and accounting (AAA) device 225, an evolved packet data gateway (ePDG) 230, and a network 235. Devices of the environment 200 may interconnect via wired connections, wireless connections, or a combination of wired and wireless connections.

The UE 105 includes one or more devices capable of receiving, generating, storing, processing, and/or providing information, such as information described herein. For example, the UE 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 110 may support, for example, a cellular radio access technology (RAT). The RAN 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The RAN 110 may transfer traffic between the UE 105 (e.g., using a cellular RAT), one or more base stations (e.g., using a wireless interface or a backhaul interface, such as a wired backhaul interface), and/or the core network 115. The RAN 110 may provide one or more cells that cover geographic areas.

In some implementations, the RAN 110 may perform scheduling and/or resource management for the UE 105 covered by the RAN 110 (e.g., the UE 105 covered by a cell provided by the RAN 110). In some implementations, the RAN 110 may be controlled or coordinated by a network controller, which may perform load balancing, network-level configuration, and/or other operations. The network controller may communicate with the RAN 110 via a wireless or wireline backhaul. In some implementations, the RAN 110 may include a network controller, a self-organizing network (SON) module or component, or a similar module or component. In other words, the RAN 110 may perform network control, scheduling, and/or network management functions (e.g., for uplink, downlink, and/or sidelink communications of the UE 105 covered by the RAN 110).

The NEF 125 includes one or more devices that support exposure of capabilities and/or events in the wireless telecommunications system to help other entities in the wireless telecommunications system discover network services.

MEC-SCEF 130 may include one or more devices that facilitate exposure of network services and capabilities to external applications, particularly in the context of edge computing environments. The MEC-SCEF 130 may bring computing resources and services closer to the end-users by being deployed at the edge of the core networks 115 and 120. The MEC-SCEF 130 may securely expose capabilities and services of the core networks 115 and 120 to external applications, and may act as an intermediary that allows external applications to interact with the core networks 115 and 120.

The application server 135 may include one or more devices capable of receiving, generating, storing, processing, providing, and/or routing information, as described elsewhere herein. The application server 135 may include a communication device and/or a computing device. For example, the application server 135 may include a server, such as an application server, a client server, a web server, a database server, a host server, a proxy server, a virtual server (e.g., executing on computing hardware), or a server in a cloud computing system. In some implementations, the application server 135 may include computing hardware used in a cloud computing environment, such as one or more serverless components (e.g., one or more serverless functions).

Some implementations are described herein as being performed within a long-term evolution (LTE) for explanatory purposes. Some implementations may be performed within a network that is not an LTE network, such as a third generation (3G) network or a 5G network.

The environment 200 may include an evolved packet system (EPS) that includes an LTE network and/or an evolved packet core (EPC) (e.g., the 4G core network 115) that operate based on a 3GPP wireless communication standard. The LTE network may include the RAN 110 that includes one or more base stations that take the form of evolved Node Bs (eNBs) via which the UE 105 communicates with the EPC. The EPC may include the MME 205, the SGW 210, the PGW 215, and/or the MEC-SCEF 130 to enable the UE 105 to communicate with the network 235 and/or an IP multimedia subsystem (IMS) core. The IMS core may include the HSS 220, the AAA 225, and/or the ePDG 230, and may manage device registration and authentication, session initiation, and/or other operations associated with the UE 105. The HSS 220, the AAA 225, and/or the ePDG 230 may reside in the EPC and/or the IMS core.

The MME 205 includes one or more devices, such as one or more server devices, capable of managing authentication, activation, deactivation, and/or mobility functions associated with the UE 105. In some implementations, the MME 205 may perform operations relating to authentication of the UE 105. Additionally, or alternatively, the MME 205 may facilitate the selection of a particular SGW 210 and/or a particular PGW 215 to provide traffic to and/or from the UE 105. The MME 205 may perform operations associated with handing off the UE 105 from a first RAN 110 to a second RAN 110 when the UE 105 is transitioning from a first cell associated with the first RAN 110 to a second cell associated with the second RAN 110. Additionally, or alternatively, the MME 205 may select another MME (not pictured), to which the UE 105 should be handed off (e.g., when the UE 105 moves out of range of the MME 205).

The SGW 210 includes one or more devices capable of routing packets. For example, the SGW 210 may include one or more data processing and/or traffic transfer devices, such as a gateway, a router, a modem, a switch, a firewall, a network interface card (NIC), a hub, a bridge, a server device, an optical add/drop multiplexer (OADM), or any other type of device that processes and/or transfers traffic. In some implementations, the SGW 210 may aggregate traffic received from one or more RANs 110 associated with the LTE network, and may send the aggregated traffic to the network 235 (e.g., via the PGW 215) and/or other network devices associated with the EPC and/or the IMS core. The SGW 210 may receive traffic from network the 235 and/or other network devices, and may send the received traffic to the UE 105 via the RAN 110. Additionally, or alternatively, the SGW 210 may perform operations associated with handing off the UE 105 to and/or from an LTE network.

The PGW 215 includes one or more devices capable of providing connectivity for the UE 105 to external packet data networks (e.g., other than the depicted EPC and/or LTE network). For example, the PGW 215 may include one or more data processing and/or traffic transfer devices, such as a gateway, a router, a modem, a switch, a firewall, a NIC, a hub, a bridge, a server device, an OADM, or any other type of device that processes and/or transfers traffic. In some implementations, the PGW 215 may aggregate traffic received from one or more SGWs 210, and may send the aggregated traffic to the network 235. Additionally, or alternatively, the PGW 215 may receive traffic from the network 235, and may send the traffic to the UE 105 via the SGW 210 and the RAN 110. The PGW 215 may record data usage information (e.g., byte usage), and may provide the data usage information to the AAA 225.

The HSS 220 includes one or more devices, such as one or more server devices, capable of managing (e.g., receiving, generating, storing, processing, and/or providing) information associated with the UE 105. For example, the HSS 220 may manage subscription information associated with the UE 105, such as information that identifies a subscriber profile of a user associated with the UE 105, information that identifies services and/or applications that are accessible to the UE 105, location information associated with the UE 105, a network identifier (e.g., a network address) that identifies the UE 105, information that identifies a treatment of the UE 105 (e.g., quality of service information, a quantity of minutes allowed per time period, a quantity of data consumption allowed per time period, etc.), and/or similar information. The HSS 220 may provide this information to one or more other devices of the environment 200 to support the operations performed by those devices.

The AAA 225 includes one or more devices, such as one or more server devices, that perform authentication, authorization, and/or accounting operations for communication sessions associated with the UE 105. For example, the AAA 225 may perform authentication operations for the UE 105 and/or a user of the UE 105 (e.g., using one or more credentials), may control access, by the UE 105, to a service and/or an application (e.g., based on one or more restrictions, such as time-of-day restrictions, location restrictions, single or multiple access restrictions, read/write restrictions, etc.), may track resources consumed by the UE 105 (e.g., a quantity of voice minutes consumed, a quantity of data consumed, etc.), and/or may perform similar operations.

The ePDG 230 includes one or more devices that provides the UE 105 with access to domain services. For example, the ePDG 230 may include one or more data processing and/or traffic transfer devices, such as a gateway, a router, a modem, a switch, a firewall, a NIC, a hub, a bridge, a server device, an OADM, or any other type of device that processes and/or transfers traffic. The ePDG 230 may perform functions, such as IP address management, support for mobile IP, quality of service (QoS) enforcement, lawful intercept and security, and/or the like.

The network 235 includes one or more wired and/or wireless networks. For example, the network 235 may include a cellular network (e.g., a 5G network, an LTE network, a 3G network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of an example environment 300 in which systems and/or methods described herein may be implemented. As shown in FIG. 3, the example environment 300 may include the UE 105, the RAN 110, the core network 120, the NEF 125, the MEC-SCEF 130, the application server 135, the IMS core network, and a data network 355. Devices and/or networks of the example environment 300 may interconnect via wired connections, wireless connections, or a combination of wired and wireless connections. Details of the UE 105, the RAN 110, the core network 120, the NEF 125, the MEC-SCEF 130, the application server 135, and the IMS core network are described above in connection with FIG. 2.

In some implementations, the core network 120 may include an example functional architecture in which systems and/or methods described herein may be implemented. For example, the core network 120 may include an example architecture of a 5G next generation (NG) core network included in a 5G wireless telecommunications system. While the example architecture of the core network 120 shown in FIG. 3 may be an example of a service-based architecture, in some implementations, the core network 120 may be implemented as a reference-point architecture and/or a 4G core network, among other examples.

As shown in FIG. 3, the core network 120 may include a number of functional elements. The functional elements may include, for example, the NEF 125, the MEC-SCEF 130, a network slice selection function (NSSF) 305, an authentication server function (AUSF) 310, a unified data management (UDM) component 315, a policy control function (PCF) 320, an application function (AF) 325, an access and mobility management function (AMF) 330, an SMF 335, a UPF 340, and/or a unified data repository (UDR) 345. These functional elements may be communicatively connected via a message bus 350. Each of the functional elements shown in FIG. 3 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 305 includes one or more devices that select network slice instances for the UE 105. By providing network slicing, the NSSF 305 allows an operator to deploy multiple substantially independent end-to-end networks potentially with the same infrastructure. In some implementations, each slice may be customized for different services.

The AUSF 310 includes one or more devices that act as an authentication server and support the process of authenticating the UE 105 in the wireless telecommunications system.

The UDM component 315 includes one or more devices that store user data and profiles in the wireless telecommunications system. The UDM component 315 may be used for fixed access and/or mobile access in the core network 120.

The PCF 320 includes one or more devices that provide a policy framework that incorporates network slicing, roaming, packet processing, and/or mobility management, among other examples.

The AF 325 includes one or more devices that support application influence on traffic routing, access to the NEF 310, and/or policy control, among other examples.

The AMF 330 includes one or more devices that act as a termination point for non-access stratum (NAS) signaling and/or mobility management, among other examples.

The SMF 335 includes one or more devices that support the establishment, modification, and release of communication sessions in the wireless telecommunications system. For example, the SMF 335 may configure traffic steering policies at the UPF 340 and/or may enforce UE IP address allocation and policies, among other examples.

The UPF 340 includes one or more devices that serve as an anchor point for intraRAT and/or interRAT mobility. The UPF 340 may apply rules to packets, such as rules pertaining to packet routing, traffic reporting, and/or handling user plane QoS, among other examples.

The UDR 345 includes one or more devices that store data grouped into distinct collections of subscription-related data, such as subscription data, policy data, structured data for exposure, application data, and/or the like. The UDR 345 may make the subscription data available, via the UDM component 315, to a number of network functions (e.g., the AUSF 310, the AMF 330, the SMF 335, and/or the like) that control the UE 105's activities within the network. The UDR 345 may make the policy data to the PCF 320. The application data may be stored in the UDR 345 by the external application function, via the NEF 310, in order to be made available to network functions that require, and are authorized to request, subscription-related data.

The message bus 350 represents a communication structure for communication among the functional elements. In other words, the message bus 350 may permit communication between two or more functional elements.

The data network 355 includes one or more wired and/or wireless data networks. For example, the data network 355 may include an IMS, a PLMN, a LAN, a WAN, a MAN, a private network such as a corporate intranet, an ad hoc network, the Internet, a fiber optic-based network, a cloud computing network, a third-party services network, an operator services network, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the example environment 300 may perform one or more functions described as being performed by another set of devices of the example environment 300.

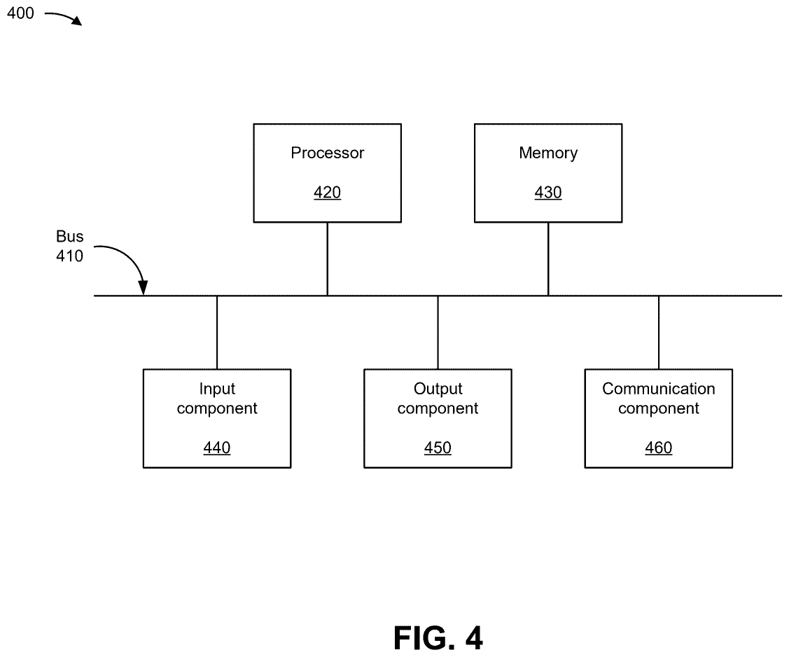

FIG. 4 is a diagram of example components of a device 400, which may correspond to the UE 105, the RAN 110, the NEF 125, the MEC-SCEF 130, the application server 135, the MME 205, the SGW 210, the PGW 215, the HSS 220, the AAA 225, the ePDG 230, the NSSF 305, the AUSF 310, the UDM component 315, the PCF 320, the AF 325, the AMF 330, the SMF 335, the UPF 340, and/or the UDR 345. In some implementations, the UE 105, the RAN 110, the NEF 125, the MEC-SCEF 130, the application server 135, the MME 205, the SGW 210, the PGW 215, the HSS 220, the AAA 225, the ePDG 230, the NSSF 305, the AUSF 310, the UDM component 315, the PCF 320, the AF 325, the AMF 330, the SMF 335, the UPF 340, and/or the UDR 345 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

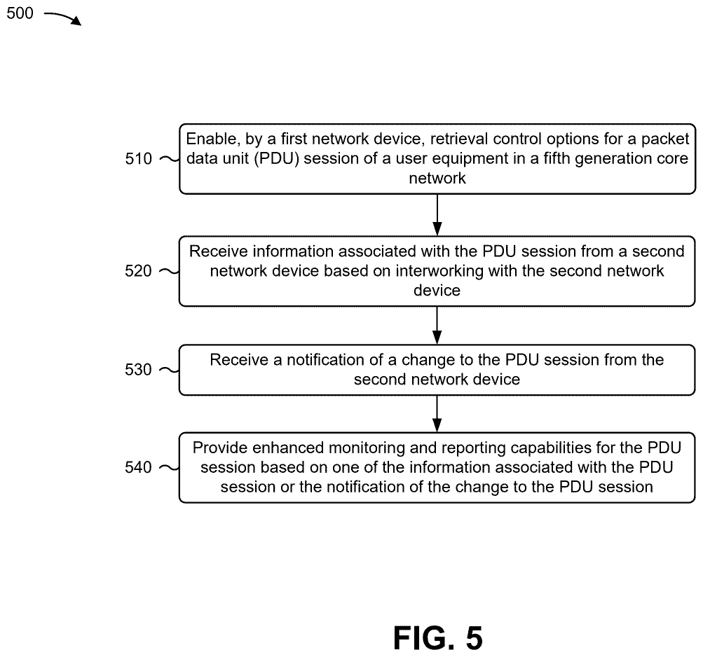

FIG. 5 is a flowchart of an example process 500 for enhancing PDU session monitoring in core networks. In some implementations, one or more process blocks of FIG. 5 may be performed by a first network device (e.g., the NEF 125). In some implementations, one or more process blocks of FIG. 5 may be performed by another device or a group of devices separate from or including the first network device, such as a second network device (e.g., the MEC-SCEF 130), and/or the like. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include enabling retrieval control options for a PDU session of a UE in a 5G core network (block 510). For example, the first network device may enable retrieval control options for a PDU session of a UE in a 5G core network, as described above. In some implementations, the retrieval control options enable the first network device to selectively monitor the PDU session of the UE in the 5G core network or another PDU session of another UE in a 4G core network.

As further shown in FIG. 5, process 500 may include receiving information associated with the PDU session from the second network device based on the retrieval control options (block 520). For example, the first network device may receive information associated with the PDU session from the second network device based on the retrieval control options, as described above. In some implementations, the information includes a NAT processed network address associated with the UE. In some implementations, the information includes a RAT type associated with the PDU session. In some implementations, the information includes a cell identifier associated with the UE.

As further shown in FIG. 5, process 500 may include receiving a notification of a change to the PDU session from the second network device (block 530). For example, the first network device may receive a notification of a change to the PDU session from the second network device, as described above. In some implementations, the notification of the change to the PDU session includes a notification indicating addition of another PDU session or removal of the PDU session.

As further shown in FIG. 5, process 500 may include providing enhanced monitoring and reporting capabilities for the PDU session based on one of the information associated with the PDU session or the notification of the change to the PDU session (block 540). For example, the first network device may provide enhanced monitoring and reporting capabilities for the PDU session based on one of the information associated with the PDU session or the notification of the change to the PDU session, as described above.

In some implementations, process 500 includes subscribing to a plurality of PDU sessions associated with a plurality of UEs via the second network device, and receiving information associated with the plurality of PDU sessions from the second network device based on subscribing to the plurality of PDU sessions. In some implementations, subscribing to the plurality of PDU sessions includes subscribing to multiple data network names associated with the plurality of UEs.

In some implementations, process 500 includes receiving a query requesting immediate reporting of the PDU session, and providing a report of the PDU session immediately based on the query. In some implementations, process 500 includes storing the information associated with the PDU session in a data structure associated with the first network device. In some implementations, process 500 includes supporting a plurality of UEs associated with a 4G core network when the 4G core network fails to support PDU session status. In some implementations, process 500 includes receiving a request for a status of the PDU session from an application server, and providing, to the application server, the information associated with the PDU session in response to the request. In some implementations, process 500 includes one of providing a NAT processed network address associated with the UE to an application server, or providing an updated NAT processed network address associated with the UE to the application server.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
enabling, by a first network device, retrieval control options for a packet data unit (PDU) session of a user equipment (UE) in a core network;
receiving, by the first network device, information associated with the PDU session from a second network device;
receiving, by the first network device, a notification of a change to the PDU session from the second network device; and
providing, by the first network device, enhanced monitoring and reporting capabilities for the PDU session based on one of the information associated with the PDU session or the notification of the change to the PDU session.

2. The method of claim 1, further comprising:
subscribing to a plurality of PDU sessions associated with a plurality of UEs via the second network device; and
receiving information associated with the plurality of PDU sessions from the second network device based on subscribing to the plurality of PDU sessions.

3. The method of claim 2, wherein subscribing to the plurality of PDU sessions comprises:
subscribing to multiple data network names associated with the plurality of UEs.

4. The method of claim 1, wherein the first network device is a network exposure function and the second network device is a multi-access edge computing service capability exposure function.

5. The method of claim 1, wherein the information includes a radio access technology type associated with the PDU session.

6. The method of claim 1, wherein the information includes a cell identifier associated with the UE.

7. The method of claim 1, wherein the information includes a network address translation processed network address associated with the UE.

8. A first network device, comprising:
one or more processors configured to:
enable retrieval control options for a packet data unit (PDU) session of a user equipment (UE) in a core network;
receive information associated with the PDU session from a second network device based on the retrieval control options,
wherein the information includes one or more of a radio access technology type, a cell identifier, or a network address translation processed network address associated with the UE;
receive a notification of a change to the PDU session from the second network device; and
provide enhanced monitoring and reporting capabilities for the PDU session based on one of the information associated with the PDU session or the notification of the change to the PDU session.

9. The first network device of claim 8, wherein the one or more processors are further configured to:
receive a query requesting immediate reporting of the PDU session; and
provide a report of the PDU session immediately based on the query.

10. The first network device of claim 8, wherein the notification of the change to the PDU session includes a notification indicating addition of another PDU session or removal of the PDU session.

11. The first network device of claim 8, wherein the one or more processors are further configured to:
store the information associated with the PDU session in a data structure associated with the first network device.

12. The first network device of claim 8, wherein the one or more processors are further configured to:
support a plurality of UEs associated with another core network when the other core network fails to support PDU session status.

13. The first network device of claim 8, wherein the retrieval control options enable the first network device to selectively monitor the PDU session of the UE in the core network or another PDU session of another UE in another core network.

14. The first network device of claim 8, wherein the one or more processors are further configured to:
receive a request for a status of the PDU session from an application server; and
provide, to the application server, the information associated with the PDU session in response to the request.

15. A non-transitory computer-readable medium storing a set of instructions, the set of instructions comprising:
one or more instructions that, when executed by one or more processors of a first network device, cause the first network device to:
enable retrieval control options for a packet data unit (PDU) session of a user equipment (UE) in a core network;
receive information associated with the PDU session from a second network device based on the retrieval control options;
receive a notification of a change to the PDU session from the second network device,
wherein the notification of the change to the PDU session includes a notification indicating addition of another PDU session or removal of the PDU session; and
provide enhanced monitoring and reporting capabilities for the PDU session based on one of the information associated with the PDU session or the notification of the change to the PDU session.

16. The non-transitory computer-readable medium of claim 15, wherein the one or more instructions further cause the first network device to:
subscribe to a plurality of PDU sessions associated with a plurality of UEs via the second network device; and
receive information associated with the plurality of PDU sessions from the second network device based on subscribing to the plurality of PDU sessions.

17. The non-transitory computer-readable medium of claim 15, wherein the one or more instructions further cause the first network device to:
receive a query requesting immediate reporting of the PDU session; and
provide a report of the PDU session immediately based on the query.

18. The non-transitory computer-readable medium of claim 15, wherein the one or more instructions further cause the first network device to one of:
provide a network address translation (NAT) processed network address associated with the UE to an application server; or
provide an updated NAT processed network address associated with the UE to the application server.

19. The non-transitory computer-readable medium of claim 15, wherein the one or more instructions further cause the first network device to:
support a plurality of UEs associated with another core network when the other core network fails to support PDU session status.

20. The non-transitory computer-readable medium of claim 15, wherein the one or more instructions further cause the first network device to:
receive a request for a status of the PDU session from an application server; and
provide, to the application server, the information associated with the PDU session in response to the request.
